(19) United States
(12) Patent Application Publication
(10) Pub. No.: US 2018/0158035 A1
(43) Pub. Date: Jun. 7, 2018

(54) INDEPENDENT PROCESSING STREAMS FOR EVENT DATA

(71) Applicant: SAP SE, Walldorf (DE)

(72) Inventors: Artur Kaufmann, Landau (DE); Fabian Hammann, Schifferstadt (DE); Dennis Kurfiss, Zaisenhausen (DE); Georg Lang, Ludwigshafen (DE)

(21) Appl. No.: 15/370,937

(22) Filed: Dec. 6, 2016

(51) Int. Cl. G06Q 20/10; G06F 17/30

(52) U.S. Cl. CPC G06Q 20/102; G06F 17/30563; G06F 17/30371; G06F 17/30377

(57) ABSTRACT

Systems and methods of independent processing streams for event data are disclosed. In some example embodiments, a computer-implemented method comprises receiving transaction data items, persisting the transaction data items in a first database, persisting a copy of the transaction data items as auxiliary data items in a second database different from the first database, detecting a manipulation of the transaction data items, updating the auxiliary data items in the second database based on the detecting of the manipulation, performing at least one online analytical processing operation using the auxiliary data items in the second database, and accessing the transaction data items in the first database and generating one or more documents using the accessed transaction data items subsequent to and independently from the performing of the at least one online analytical processing operation, with the generating of the document(s) being one of a plurality of periodic document generation operations.

### TECHNICAL FIELD

The present application relates generally to the technical field of data processing, and, in various embodiments, to systems and methods of independent processing streams for event data.

### BACKGROUND

In current data processing systems, the timing of when a certain aspect of data is recognized may be an issue. For example, the ability to recognize one or more particular aspects of data, such as via an online analytical processing (OLAP) operation, can be tied to and be dependent upon the generation of a particular type of document. Such dependency results in an inefficient use of resources of the data processing system. For example, often, a simulated document is generated in order to enable the recognition of the particular aspect of data, and then the simulated document is subsequently reversed. Such a solution for overcoming this obstacle to data recognition causes a waste of precious resources of the data processing system, decreases the speed of the data processing system, and makes the data processing system prone to error.

### BRIEF DESCRIPTION OF THE DRAWINGS

Some example embodiments of the present disclosure are illustrated by way of example and not limitation in the figures of the accompanying drawings, in which like reference numbers indicate similar elements.

FIG. 1 is a network diagram illustrating a client-server system, in accordance with some example embodiments.

FIG. 2 is a block diagram illustrating enterprise applications and services in an enterprise application platform, in accordance with some example embodiments.

FIG. 3 is a block diagram illustrating a data processing system, in accordance with some example embodiments.

FIG. 4 is a block diagram illustrating an operational flow of a data processing system, in accordance with some example embodiments.

FIG. 5 is a flowchart illustrating a method of decoupling processing streams in a data processing system, in accordance with some example embodiments.

FIG. 6 is a block diagram illustrating another operational flow of a data processing system, in accordance with some example embodiments.

FIG. 7 is a block diagram illustrating yet another operational flow of a data processing system, in accordance with some example embodiments.

FIG. 8 is a block diagram illustrating a mobile device, in accordance with some example embodiments.

FIG. 9 is a block diagram of an example computer system on which methodologies described herein can be executed, in accordance with some example embodiments.

### DETAILED DESCRIPTION

Example methods and systems of independent processing streams for event data are disclosed. In the following description, for purposes of explanation, numerous specific details are set forth in order to provide a thorough understanding of example embodiments. It will be evident, however, to one skilled in the art that the present embodiments can be practiced without these specific details.

The present disclosure offers a technical solution to the problem of data recognition being dependent upon document generation by decoupling the data recognition processing stream from the document generation processing stream in the data processing system. As a result, some technical effects of the system and method of the present disclosure are to create a leaner data processing system, decreasing resource consumption, increasing the speed, and reducing the risk of error in the data processing system. Additionally, other technical effects will be apparent from this disclosure as well.

In some example embodiments, a computer-implemented method comprises receiving a plurality of transaction data items, with each one of the plurality of transaction data items corresponding to a distinct event; persisting the plurality of transaction data items in a first database (e.g., a transaction data storage) in response to, or otherwise based on, the receiving the plurality of transaction data items; persisting a copy of the plurality of transaction data items as a plurality of auxiliary data items in a second database (e.g., an auxiliary data storage) different from the first database in response to, or otherwise based on, the receiving the plurality of transaction data items; detecting a manipulation of the plurality of transaction data items; updating the plurality of auxiliary data items in the second database based on the detecting of the manipulation of the plurality of transaction data items; performing at least one online analytical processing operation using the plurality of auxiliary data items in the second database; and accessing the plurality of transaction data items in the first database and generating one or more documents using the accessed plurality of transaction data items subsequent to and independently from the performing of the at least one online analytical processing operation, with the generating of the one or more documents being one of a plurality of periodic document generation operations using data from the first database.

In some example embodiments, the corresponding distinct events for the plurality of transaction data items comprise telecommunication events. In some example embodiments, the telecommunication events comprise at least one of a voice call event, a text messaging event, and a data transmission event, the data transmission event using an Internet Protocol network.

In some example embodiments, the operations further comprise updating the plurality of auxiliary data items in the second database based on the generating of the one or more documents.

In some example embodiments, the plurality of transaction data items comprises a plurality of billable items. In some example embodiments, the generating of the one or more documents comprises generating one or more invoice documents. In some example embodiments, the operations further comprise recognizing revenue from the plurality of billable items using the plurality of auxiliary data items in the second database prior to and independently of the generating of the one or more invoice documents. In some example embodiments, the operations further comprise posting the recognized revenue from the plurality of billable items to one or more accounts prior to and independently of the generating of the one or more invoice documents.

The methods or embodiments disclosed herein may be implemented as a computer system having one or more modules (e.g., hardware modules or software modules). Such modules may be executed by one or more hardware processors of the computer system. In some example embodiments, a non-transitory machine-readable storage device can store a set of instructions that, when executed by at least one processor, causes the at least one processor to perform the operations and method steps discussed within the present disclosure.

The details of one or more variations of the subject matter described herein are set forth in the accompanying drawings and the description below. Other features and benefits of the subject matter described herein will be apparent from the description and drawings, and from the claims.

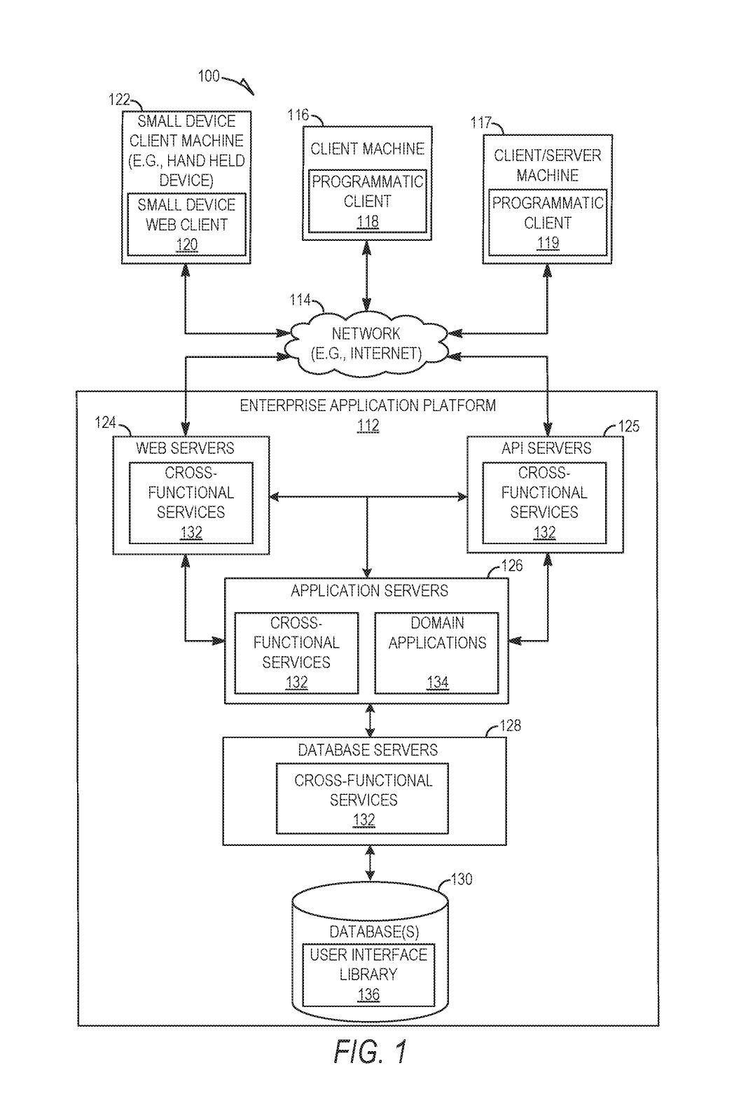

FIG. 1 is a network diagram illustrating a client-server system 100, in accordance with some example embodiments. A platform (e.g., machines and software), in the example form of an enterprise application platform 112, provides server-side functionality, via a network 114 (e.g., the Internet) to one or more clients. FIG. 1 illustrates, for example, a client machine 116 with programmatic client 118 (e.g., a browser), a small device client machine 122 with a small device web client 120 (e.g., a browser without a script engine), and a client/server machine 117 with a programmatic client 119.

Turning specifically to the example enterprise application platform 112, web servers 124 and Application Program Interface (API) servers 125 can be coupled to, and provide web and programmatic interfaces to, application servers 126. The application servers 126 can be, in turn, coupled to one or more database servers 128 that facilitate access to one or more databases 130. The cross-functional services 132 can include relational database modules to provide support services for access to the database(s) 130, which includes a user interface library 136. The web servers 124, API servers 125, application servers 126, and database servers 128 can host cross-functional services 132. The application servers 126 can further host domain applications 134.

The cross-functional services 132 provide services to users and processes that utilize the enterprise application platform 112. For instance, the cross-functional services 132 can provide portal services (e.g., web services), database services and connectivity to the domain applications 134 for users that operate the client machine 116, the client/server machine 117 and the small device client machine 122. In addition, the cross-functional services 132 can provide an environment for delivering enhancements to existing applications and for integrating third-party and legacy applications with existing cross-functional services 132 and domain applications 134. Further, while the system 100 shown in FIG. 1 employs a client-server architecture, the embodiments of the present disclosure are of course not limited to such an architecture, and could equally well find application in a distributed, or peer-to-peer, architecture system.

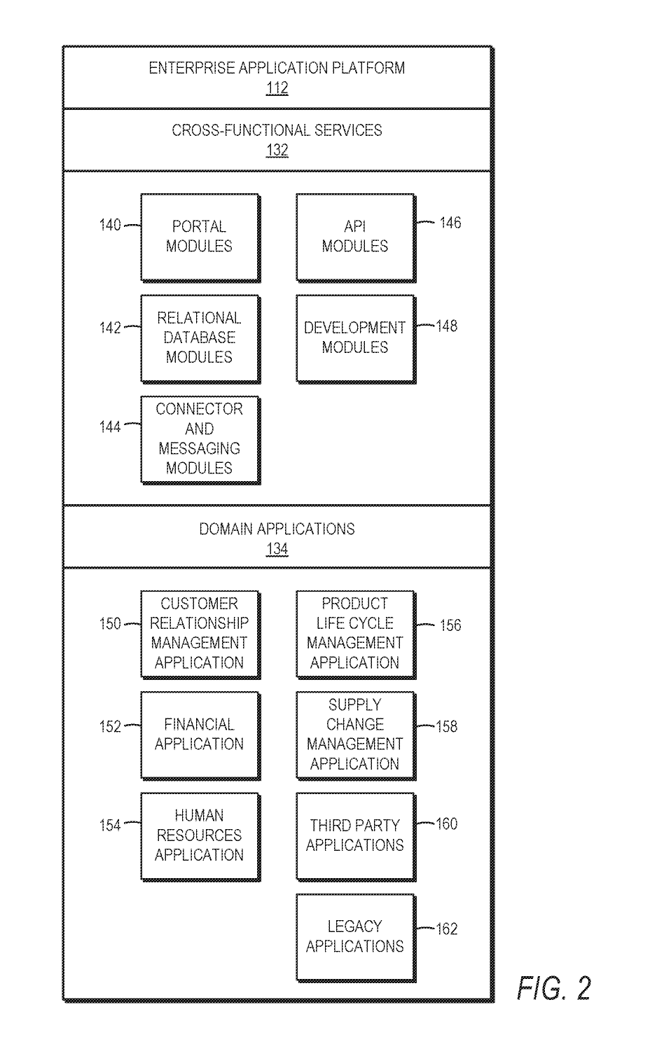

The enterprise application platform 112 can implement partition level operation with concurrent activities. For example, the enterprise application platform 112 can implement a partition level lock, a schema lock mechanism, manage activity logs for concurrent activity, generate and maintain statistics at the partition level, and efficiently build global indexes. The enterprise application platform 112 is described in greater detail below in conjunction with FIG. 2.

FIG. 2 is a block diagram illustrating enterprise applications and services in an enterprise application platform 112, in accordance with an example embodiment. The enterprise application platform 112 can include cross-functional services 132 and domain applications 134. The cross-functional services 132 can include portal modules 140, relational database modules 142, connector and messaging modules 144, API modules 146, and development modules 148.

The portal modules 140 can enable a single point of access to other cross-functional services 132 and domain applications 134 for the client machine 116, the small device client machine 122, and the client/server machine 117. The portal modules 140 can be utilized to process, author and maintain web pages that present content (e.g., user interface elements and navigational controls) to the user. In addition, the portal modules 140 can enable user roles, a construct that associates a role with a specialized environment that is utilized by a user to execute tasks, utilize services and exchange information with other users and within a defined scope. For example, the role can determine the content that is available to the user and the activities that the user can perform. The portal modules 140 include a generation module, a communication module, a receiving module and a regenerating module. In addition the portal modules 140 can comply with web services standards and/or utilize a variety of Internet technologies including Java, J2EE, SAP's Advanced Business Application Programming Language (ABAP) and Web Dynpro, XML, JCA, JAAS, X.509, LDAP, WSDL, WSRR, SOAP, UDDI and Microsoft .NET.

The relational database modules 142 can provide support services for access to the database(s) 130, which includes a user interface library 136. The relational database modules 142 can provide support for object relational mapping, database independence and distributed computing. The relational database modules 142 can be utilized to add, delete, update and manage database elements. In addition, the relational database modules 142 can comply with database standards and/or utilize a variety of database technologies including SQL, SQLDBC, Oracle, MySQL, Unicode, JDBC, or the like.

The connector and messaging modules 144 can enable communication across different types of messaging systems that are utilized by the cross-functional services 132 and the domain applications 134 by providing a common messaging application processing interface. The connector and messaging modules 144 can enable asynchronous communication on the enterprise application platform 112.

The API modules 146 can enable the development of service-based applications by exposing an interface to existing and new applications as services. Repositories can be included in the platform as a central place to find available services when building applications.

The development modules 148 can provide a development environment for the addition, integration, updating and extension of software components on the enterprise application platform 112 without impacting existing cross-functional services 132 and domain applications 134.

Turning to the domain applications 134, the customer relationship management application 150 can enable access to and can facilitate collecting and storing of relevant personalized information from multiple data sources and business processes. Enterprise personnel that are tasked with developing a buyer into a long-term customer can utilize the customer relationship management applications 150 to provide assistance to the buyer throughout a customer engagement cycle.

Enterprise personnel can utilize the financial applications 152 and business processes to track and control financial transactions within the enterprise application platform 112. The financial applications 152 can facilitate the execution of operational, analytical and collaborative tasks that are associated with financial management. Specifically, the financial applications 152 can enable the performance of tasks related to financial accountability, planning, forecasting, and managing the cost of finance.

The human resource applications 154 can be utilized by enterprise personnel and business processes to manage, deploy, and track enterprise personnel. Specifically, the human resource applications 154 can enable the analysis of human resource issues and facilitate human resource decisions based on real time information.

The product life cycle management applications 156 can enable the management of a product throughout the life cycle of the product. For example, the product life cycle management applications 156 can enable collaborative engineering, custom product development, project management, asset management and quality management among business partners.

The supply chain management applications 158 can enable monitoring of performances that are observed in supply chains. The supply chain management applications 158 can facilitate adherence to production plans and on-time delivery of products and services.

The third-party applications 160, as well as legacy applications 162, can be integrated with domain applications 134 and utilize cross-functional services 132 on the enterprise application platform 112.

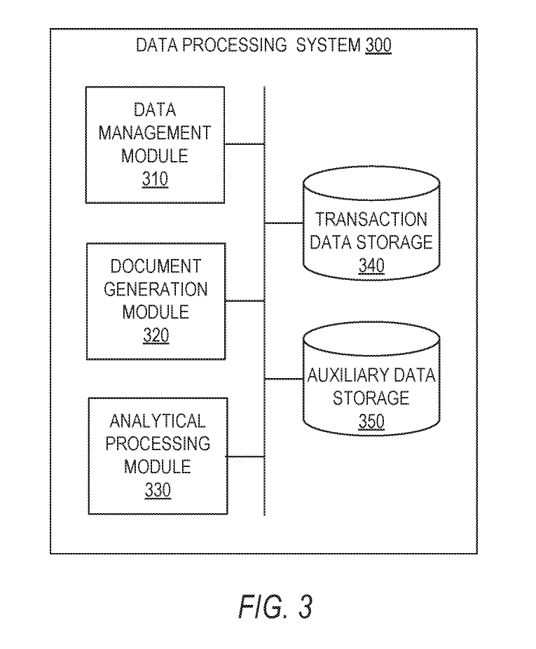

FIG. 3 is a block diagram illustrating a data processing system 300, in accordance with some example embodiments. In some example embodiments, the data processing system 300 comprises any combination of one or more of a data management module 310, a document generation module 320, an analytical processing module 330, a transaction data storage 340, and an auxiliary data storage 350.

In some example embodiments, the modules 310, 320, and 330 and the data storages 340 and 350 reside on a machine having a memory and at least one processor (not shown). In some example embodiments, the modules 310, 320, and 330 and the data storages 340 and 350 reside on the same machine, while in other example embodiments, one or more of modules 310, 320, and 330 and the data storages 340 and 350 reside on separate remote machines that communicate with each other via a network (e.g., network 114 in FIG. 1). In some example embodiments, the modules 310, 320, and 330 and the data storages 340 and 350 can be incorporated into the enterprise application platform 112 in FIG. 1 (e.g., on application server(s) 126). However, it is contemplated that other configurations are also within the scope of the present disclosure.

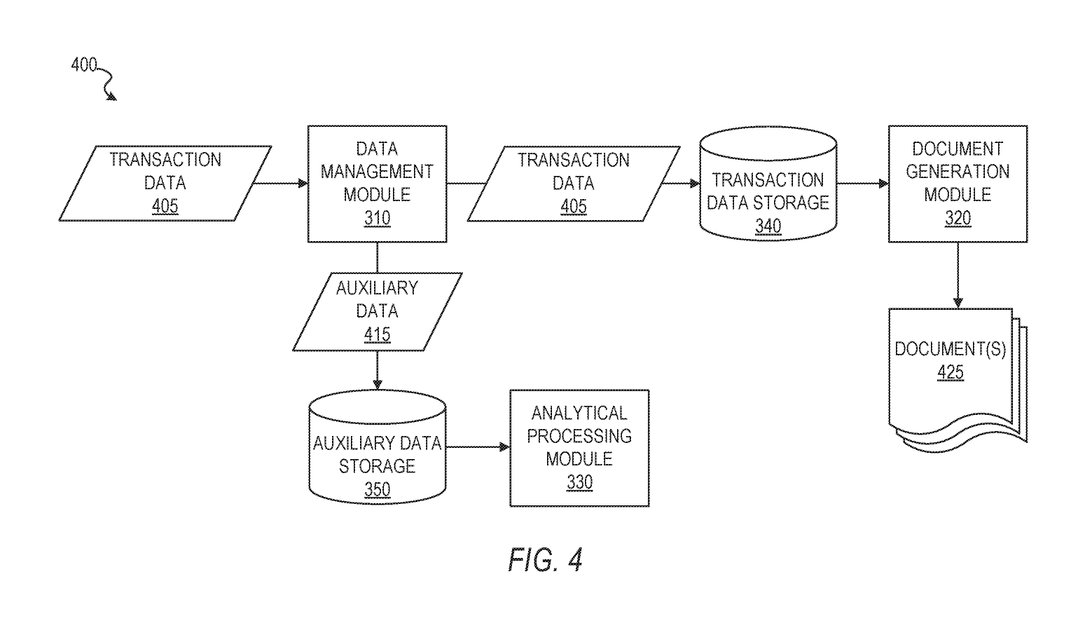

FIG. 4 is a block diagram illustrating an operational flow 400 of the data processing system 300, in accordance with some example embodiments.

In some example embodiments, the data management module 310 is configured to receive transaction data items 405, with each of the transaction data items 405 corresponding to its own distinct event (e.g., transaction). Each transaction data item 405 may comprise information recorded from a transaction. In some example embodiments, a transaction comprises a one-way exchange (e.g., entity A gives something to entity B) or a two-way exchange (e.g., entity A gives something to entity B, and entity B gives something to entity A). The information recorded from the transaction may include, but is not limited to, financial data, logistical data, and work-related data. It is contemplated that other types of transactional information is also within the scope of the present disclosure.

In some example embodiments, the distinct events corresponding to the transaction data items 405 comprise telecommunication events. Such telecommunication events may include, but are not limited to, voice call events (e.g., a voice call made via a mobile phone), text messaging events (e.g., a text message sent via a mobile phone), and data transmission events that use an Internet Protocol network (e.g., accessing multimedia resources on a cell phone via the Internet). It is contemplated that other types of events are also within the scope of the present disclosure.

In some example embodiments, the data management module 310 is configured to store and persist the transaction data items 405 in the transaction data storage 340 in response to or otherwise based on receiving the transaction data items 405. The transaction data storage 340 may comprise one or more databases (e.g., database(s) 130 in FIG. 1). However, the transaction data storage 340 may be implemented using other types of data storage mechanisms as well.

In some example embodiments, the document generation module 320 is configured to access one or more of the transaction data items 405 in the transaction data storage 340 and generate one or more documents 425 using the accessed transaction data item(s) 405. This access of the transaction data items 405 and generation of the document(s) 425 may be performed periodically. For example, the document generation module 320 may access the transaction data storage 340 and generate one or more documents 425 at regular intervals of time (e.g., monthly), such as accessing data in the transaction data storage 340 and generating one or more invoice documents on the last day of every month.

In some example embodiments, the data management module 310 is configured to store and persist a copy of the transaction data items 405 as auxiliary data items 415 in the auxiliary data storage 350, which is different from the transaction data storage 340. The auxiliary data storage 350 may comprise one or more databases (e.g., database(s) 130 in FIG. 1). However, the auxiliary data storage 350 may be implemented using other types of data storage mechanisms as well.

In some example embodiments, the analytical processing module 330 is configured to perform at least one online analytical processing (OLAP) operation using one or more of the auxiliary data items 415 in the auxiliary data storage 350. The data processing system 300 decouples the analytical processing from the document generation, such that the analytical processing module 330 can perform one or more OLAP operations prior to and independently from the periodic generation of one or more documents 425 by the document generation module 320. For example, in an embodiment where the document generation module 320 generates one or more documents 425 based on one or more transaction data items 405 in the transaction data storage 340 on the last day of every month and is next scheduled to perform such periodic document generation using one or more transaction data items 405 in the transaction data storage 30 on November 30th, the decoupling feature of the data processing system 300 enables the analytical processing module 330 to perform one or more OLAP operations on the auxiliary data items 415 in the auxiliary data storage 350, which correspond to the transaction data items 405 in the transaction data storage 340, anytime between November 1^{st} and November 29^{th}, thereby removing the dependency of the analytical processing on the document generation.

In some example embodiments, the data management module 310 is configured to detect a manipulation of the transaction data items 405 in the transaction data storage 340. Such manipulation may include, but is not limited to, the transaction data items 405 being added to the transaction data storage 340, deleted from the transaction data storage 340, or modified. Such modification may also include the generation of documents 425 using the transaction data items 405 by the document generation module 320. It is contemplated that other types of manipulation of the transaction data items 405 are also within the scope of the present disclosure.

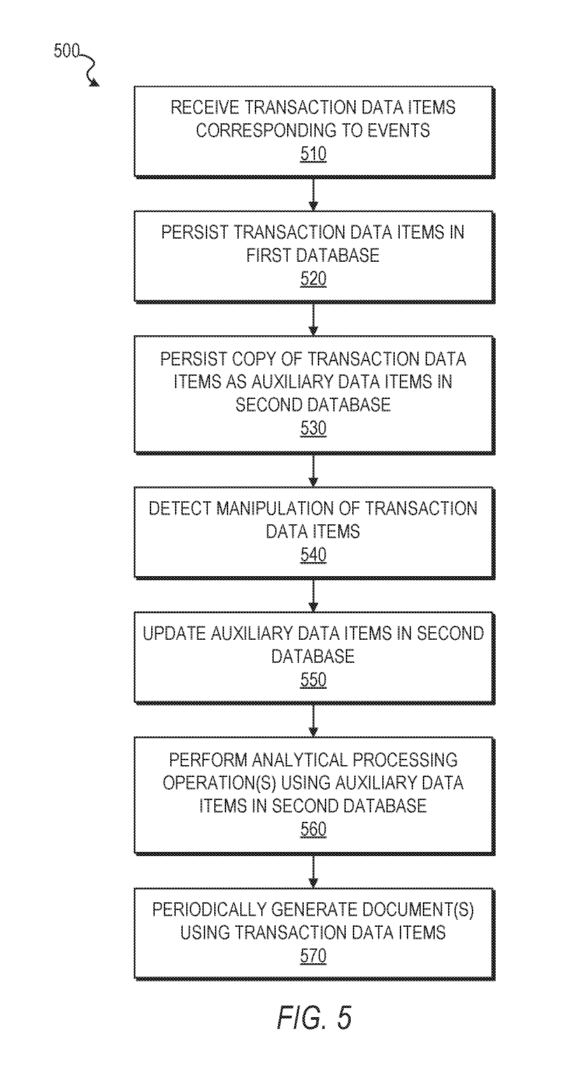

FIG. 5 is a flowchart illustrating a method 500 of decoupling processing streams in a data processing system, in accordance with some example embodiments. Method 500 can be performed by processing logic that can comprise hardware (e.g., circuitry, dedicated logic, programmable logic, microcode, etc.), software (e.g., instructions run on a processing device), or a combination thereof. In one example embodiment, the method 500 is performed by the data processing system 300 of FIG. 3, or any combination of one or more of its components or modules (e.g., data management module 310, document generation module 320, analytical processing module 330), as described above.

At operation 510, the data processing system 300 receives a plurality of transaction data items 405, with each one of the plurality of transaction data items 405 corresponding to a distinct event. In some example embodiments, the corresponding distinct events for the plurality of transaction data items 405 comprise telecommunication events. In some example embodiments, the telecommunication events comprise at least one of a voice call event, a text messaging event, and a data transmission event that uses an Internet Protocol network.

At operation 520, the data processing system 300 persists the plurality of transaction data items 405 in a first database (e.g., transaction data storage 340) in response to, or otherwise based on, the receiving of the plurality of transaction data items 405.

At operation 530, the data processing system 300 persists a copy of the plurality of transaction data items 405 as a plurality of auxiliary data items 415 in a second database (e.g., auxiliary data storage 350) different from the first database in response to, or otherwise based on, the receiving the plurality of transaction data items.

At operation 540, the data processing system 300 detects a manipulation of the plurality of transaction data items 405.

At operation 550, the data processing system 300 updates the plurality of auxiliary data items 415 in the second database based on the detecting of the manipulation of the plurality of transaction data items 405.

At operation 560, the data processing system 300 performs at least one online analytical processing operation using the plurality of auxiliary data items 415 in the second database.

At operation 570, the data processing system 300 accesses the plurality of transaction data items 404 in the first database and generates one or more documents 425 using the accessed plurality of transaction data items 405 subsequent to and independently from the performing of the at least one online analytical processing operation. In some example embodiments, the generating of the one or more documents 425 is one of a plurality of periodic document generation operations using data from the first database. In some example embodiments, the manipulation of the plurality of transaction data items 405 in operation 540 comprises the generating of one or more documents 425 and the data processing system 300 updates the plurality of auxiliary data items 415 in the second database based on this manipulation.

It is contemplated that any of the other features described within the present disclosure can be incorporated into method 500.

In some example embodiments, the features of the data processing system 300 are implemented within an invoicing system. The invoicing system may comprise a convergent invoicing system that generates a convergent bill, where billing data from various sources is aggregated into a single invoice and is processed together. In some example embodiments, the convergent invoicing system enables a user to pull information from several billing streams and service events to consolidate the information into a single invoice. Users of the convergent invoicing system can achieve a single view of a customer with historical items such as overdue open items, disputed charges, and payments made.

There are many use-cases for an invoicing system where it would be beneficial to implement the features of the present disclosure to accrue and/or post receivables and related revenue independently from each other and independently from invoice creation. Such use-cases include, but are not limited to:
1) Prepaid business: receivables are already paid; posting of (already-paid) usage revenues for prepaid telecommunications services, potentially on anonymous accounts, means a huge data load which could be avoided;
2) Unbilled revenue postings for fulfilled services: timely recognition of revenue, independent from invoicing raw data for receivables/revenue, arrive daily in enterprise resource planning (ERP), but an invoice is created at the end of the month; Usually, revenue is posted when the invoice is created. However, when management requires daily feedback about unbilled revenue, the features of the present disclosure can be used to provide information about unbilled revenue prior to and independently of invoice creation;
3) Event-based deferred revenue: customer purchases a “season pass” for a particular TV series; no service has been provided yet, but a receivable against the customer has to be posted; the revenue portion has to be posted as deferred and a transfer of the posting to real revenue is performed when the service is provided (e.g., when a new episode is published). However, the availability of a new episode is not a receivable and no invoice should be created due to data volume considerations; and
4) Time-based deferred revenue: a variant of use case 3, whereby the transfer of posting to real revenue is not triggered by an external event, but rather by predefined dates.

In some example embodiments, the transaction data item 405 comprise a billable item. A billable item comprises a transaction that is to be billed to an entity, such as by generating an invoice for a customer consuming a service corresponding to the transaction. In some example embodiments, billable items are an alternative to using a product for billing clients, allowing for the addition of items for a client to be billed that are not limited to preset products or fixed cycles.

Revenue recognition is an accounting principle under generally accepted accounting principles (GAAP) that determines the specific conditions under which revenue is recognized or accounted for. Generally, revenue is recognized only when a specific critical event has occurred and the amount of revenue is measurable. However, there are several situations in which exceptions may apply. In current invoicing systems, revenue recognition is not performed until invoice creation is performed, thereby making the revenue recognition of billable items dependent upon the invoice creation for the billable items. Such dependency may be sufficient for postpaid scenarios, but is unsatisfactory for prepaid scenarios where the user of the invoicing system wants to recognize the revenue as soon as possible rather than wait for the invoice generation to be performed.

In some scenarios, revenue recognition may be sufficient at the time of invoicing, but one may record the revenue (e.g., as unbilled revenue) as soon as possible and not want to wait for the invoicing process to happen in order to obtain revenue information. Current invoicing systems suffer from a problem of timely recognition of revenues, as they tie the recognition of revenue to invoice creation. However, there are use cases where the user would like to recognize the revenue when a service is provided, instead of waiting until the monthly invoice creation at the end of the month.

In some example embodiments, the data processing system 300 decouples revenue recognition (e.g., recording) from invoice creation, enabling the capturing of revenue data as soon as possible. For example, when billable items are captured in the invoicing system, revenue information, such as monetary amount, quantity, consumption period, and corresponding receivable and revenue account, is recorded and stored in a highly aggregated manner. The revenue data can then be monitored or used for accrued revenue journal entries or other operations, such as OLAP operations.

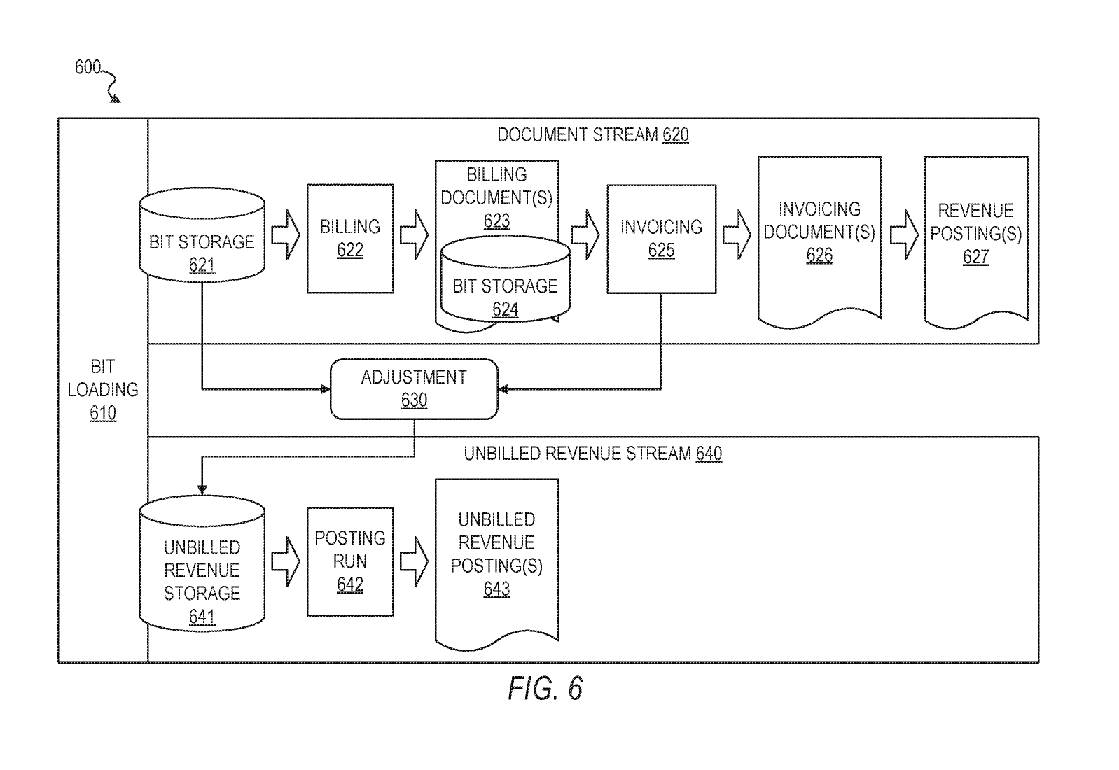

FIG. 6 is a block diagram illustrating another operational flow 600 of the data processing system 300, in accordance with some example embodiments. The operation flow 600 may employ the features, functions, and operations discussed above with respect to the data processing system 300, decoupling an unbilled revenue process stream 640 from a document process stream 620.

At 610, one or more billable items are loaded into the data processing system 300 and stored in an initial billable item storage 621. At 622, a billing process is performed, as part of the document process stream 620, using the billable items loaded into the billable item storage 621, producing one or more billing documents 623 that are stored in a billable item storage 624. At 625, an invoicing process is performed using one or more of the billing documents 623 in the billable item storage 624 (e.g., transaction data items in the billing documents 623), producing one or more invoicing documents 626. As part of the document process stream 620, the invoicing documents 626 are used to generate revenue postings 627.

As part of the operational flow 600, the unbilled revenue process stream 640 is decoupled from the document process stream 620, thereby enabling users of the data processing system 300 to access, view, and perform operations (e.g., OLAP operations) on unbilled revenue data of the billable items that are loaded into the data processing system 300 without having to wait for the invoicing process 625. At 641, the one or more billable items loaded into the billable item storage 621 in the document process stream 620 are also stored and persisted in an unbilled revenue storage 641. Additionally, at 630, an adjustment process is performed to adjust an unbilled revenue storage 641 to reflect billable item data that has been added to, deleted from, or modified within the billable item storage 621. Additionally, an adjustment process can also be performed at 630 in response to the performance of the invoicing process at 625 in order to reflect changes to the data in the unbilled revenue storage 641 as a result of the invoicing process 625, such as an invoicing document 626 being created for a billable item represented in the unbilled revenue storage 641. As part of the unbilled revenue process stream 640, a posting run 642 may be performed, resulting in the production of one or more unbilled revenue postings 643.

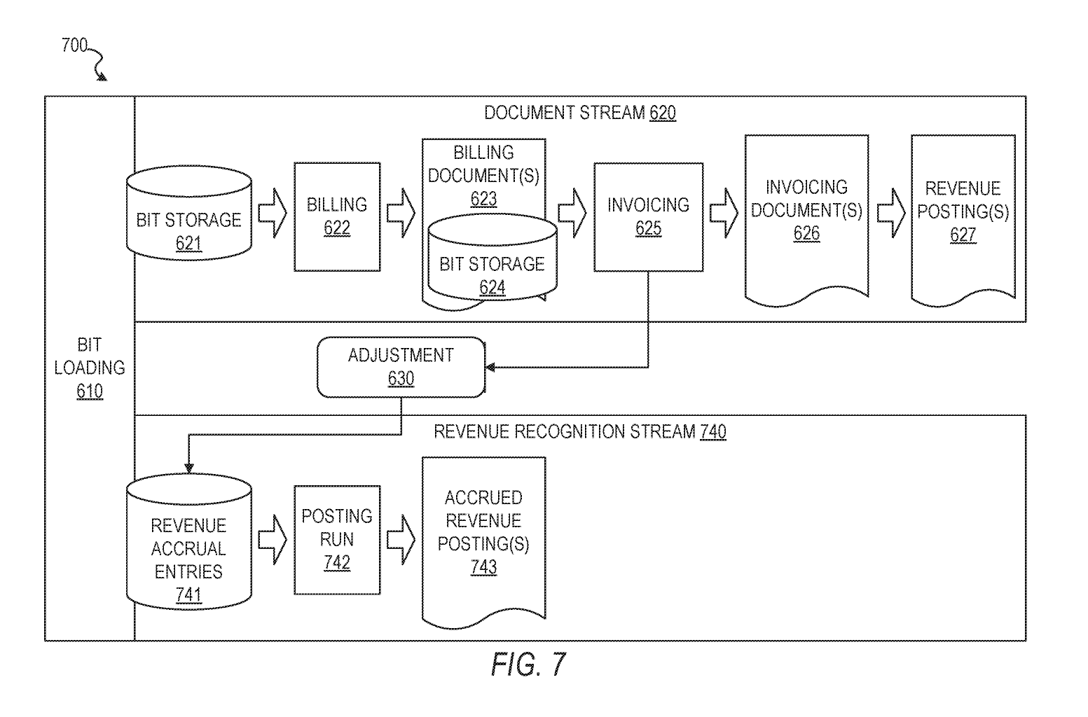

FIG. 7 is a block diagram illustrating yet another operational flow 700 of the data processing system 300, in accordance with some example embodiments. The operation flow 700 may employ the features, functions, and operations discussed above with respect to the data processing system 300, decoupling a revenue recognition process 740 from a document process stream 620.

At 610, one or more billable items are loaded into the data processing system 300 and stored in an initial billable item storage 621. At 622, a billing process is performed, as part of a document process stream 620, using the billable items loaded into the billable item storage 621, producing one or more billing documents 623 that are stored in a billable item storage 624. At 625, an invoicing process is performed using one or more of the billing documents 623 in the billable item storage 624 (e.g., transaction data items in the billing documents 623), producing one or more invoicing documents 626. As part of the document process stream 620, the invoicing documents 626 are used to generate revenue postings 627.

As part of the operational flow 700, the revenue recognition process stream 740 is decoupled from the document process stream 620, thereby enabling users of the data processing system 300 to access, view, and perform operations (e.g., OLAP operations) on revenue accrual data of the billable items that are loaded into the data processing system 300 without having to wait for the invoicing process 625. At 741, the one or more billable items loaded into the billable item storage 621 in the document process stream 620 are also stored and persisted in a revenue accrual entries storage 741. Additionally, an adjustment process can also be performed at 630 in response to the performance of the invoicing process at 625 in order to reflect changes to the data in the revenue accrual entries storage 741 as a result of the invoicing process 625, such as an invoicing document 626 being created for a billable item represented in the revenue accrual entries storage 741. As part of the revenue recognition process stream 740, a posting run 742 may be performed, resulting in the production of one or more accrued revenue postings 743.

In some example embodiments, the billable items loaded into the storages 621, 641, and 741 in FIGS. 6 and 7 are created based on telecommunication events (e.g., voice calls, text messages, data transmissions) for a plurality of customers. In just one month, billions of billable item records for which an invoice is to be created can be stored and persisted in the data processing system 300. Every day, the data processing system 300 can receive new billable items loaded into the data processing system 300. These billable items may comprise billable items corresponding to prepaid services that have already been consumed, resulting in a service that has already been paid for and already consumed, but not yet invoiced. As a result, these billable items are a subject for unbilled revenue postings.

In some example embodiments, the data processing system 300 implements a new persistency for revenue recognition items. This persistency exists in parallel to the persistency to store invoice raw data, such as the billable items. The revenue recognition persistency can be filled synchronously when billable items are received. In other example embodiments, the revenue recognition items can be created asynchronously from the creation of billable items.

In some example embodiments, the persistency of revenue recognition items is processed in parallel with the document process stream 620, and aggregated revenue postings are created. In some example embodiments, the aggregated postings are not made on business partner level, but on a more aggregated level, such as on a product level, ensuring that a general ledger of an invoicing system is not flooded with intermediate postings which do not require business partner detail. The drill-down to the individual business partner from an aggregate posting is still possible via the revenue recognition items.

Without the decoupling features of the present disclosure, customers are forced to perform a mass simulation of data in the document process stream 620 and to create automatic reversal triggers for the simulated invoice document to any accrual postings of an account, which is very cumbersome, or they are forced to perform a batch simulation followed by a manual posting, which is error prone.

The technical solution provided by the features of the present disclosure increases the speed of the data processing system 300 by decoupling an analytics process stream from a document generation stream, thereby removing the requirement that a revenue recognition operation only be performed with the standard invoicing operation. Additionally, even though the data processing system 300 can generate aggregated postings, it is still possible to drill down to the level of the individual customer transactions.

Decoupling the posting of revenue from the process of creating an invoice or a bill, implemented by the features of the present disclosure, provides the following benefits: 1) direct visibility in financials about unbilled/deferred revenue for OLAP operations; 2) a leaner process with less process steps and lower resource consumption compared to current invoicing systems; and 3) summary postings to unbilled/deferred revenue accounts, while not losing the references to individual business partners, resulting in a reduced memory footprint.

The following numbered examples are embodiments.

1. A system comprising:

at least one processor; and

a non-transitory computer-readable medium storing executable instructions that, when executed, cause the at least one processor to perform operations comprising:
receiving a plurality of transaction data items, each one of the plurality of transaction data items corresponding to a distinct event;
persisting the plurality of transaction data items in a first database in response to the receiving the plurality of transaction data items;
persisting a copy of the plurality of transaction data items as a plurality of auxiliary data items in a second database different from the first database;
detecting a manipulation of the plurality of transaction data items;
updating the plurality of auxiliary data items in the second database based on the detecting of the manipulation of the plurality of transaction data items;
performing at least one online analytical processing operation using the plurality of auxiliary data items in the second database; and
accessing the plurality of transaction data items in the first database and generating one or more documents using the accessed plurality of transaction data items subsequent to and independently from the performing of the at least one online analytical processing operation, the generating of the one or more documents being one of a plurality of periodic document generation operations using data from the first database.

2. The system of example 1, wherein the corresponding distinct events for the plurality of transaction data items comprise telecommunication events.

3. The system of example 2, wherein the telecommunication events comprise at least one of a voice call event, a text messaging event, and a data transmission event, the data transmission event using an Internet Protocol network.

4. The system of any one of examples 1 to 3, wherein the operations further comprise updating the plurality of auxiliary data items in the second database based on the generating of the one or more documents.

5. The system of any one of examples 1 to 4, wherein the plurality of transaction data items comprises a plurality of billable items.

6. The system of example 5, wherein the generating of the one or more documents comprises generating one or more invoice documents.

7. The system of example 6, wherein the operations further comprise recognizing revenue from the plurality of billable items using the plurality of auxiliary data items in the second database prior to and independently of the generating of the one or more invoice documents.

8. The system of example 7, wherein the operations further comprise posting the recognized revenue from the plurality of billable items to one or more accounts prior to and independently of the generating of the one or more invoice documents.

9. A computer-implemented method comprising:

receiving a plurality of transaction data items, each one of the plurality of transaction data items corresponding to a distinct event;

persisting the plurality of transaction data items in a first database in response to the receiving the plurality of transaction data items;

persisting a copy of the plurality of transaction data items as a plurality of auxiliary data items in a second database different from the first database;

detecting a manipulation of the plurality of transaction data items;

updating the plurality of auxiliary data items in the second database based on the detecting of the manipulation of the plurality of transaction data items;

performing, by a machine having a memory and at least one hardware processor, at least one online analytical processing operation using the plurality of auxiliary data items in the second database; and

accessing the plurality of transaction data items in the first database and generating one or more documents using the accessed plurality of transaction data items subsequent to and independently from the performing of the at least one online analytical processing operation, the generating of the one or more documents being one of a plurality of periodic document generation operations using data from the first database.

10. The computer-implemented method of example 9, wherein the corresponding distinct events for the plurality of transaction data items comprise telecommunication events.

11. The computer-implemented method of example 10, wherein the telecommunication events comprise at least one of a voice call event, a text messaging event, and a data transmission event, the data transmission event using an Internet Protocol network.

12. The computer-implemented method of any one of examples 9 to 11, further comprising updating the plurality of auxiliary data items in the second database based on the generating of the one or more documents.

13. The computer-implemented method of any one of examples 9 to 12, wherein the plurality of transaction data items comprises a plurality of billable items.

14. The computer-implemented method of example 13, wherein the generating of the one or more documents comprises generating one or more invoice documents.

15. The computer-implemented method of example 14, further comprising recognizing revenue from the plurality of billable items using the plurality of auxiliary data items in the second database prior to and independently of the generating of the one or more invoice documents.

16. The computer-implemented method of example 15, further comprising posting the recognized revenue from the plurality of billable items to one or more accounts prior to and independently of the generating of the one or more invoice documents.

17. A machine-readable medium carrying a set of instructions that, when executed by at least one processor, causes the at least one processor to carry out the method of any one of examples 9 to 16.

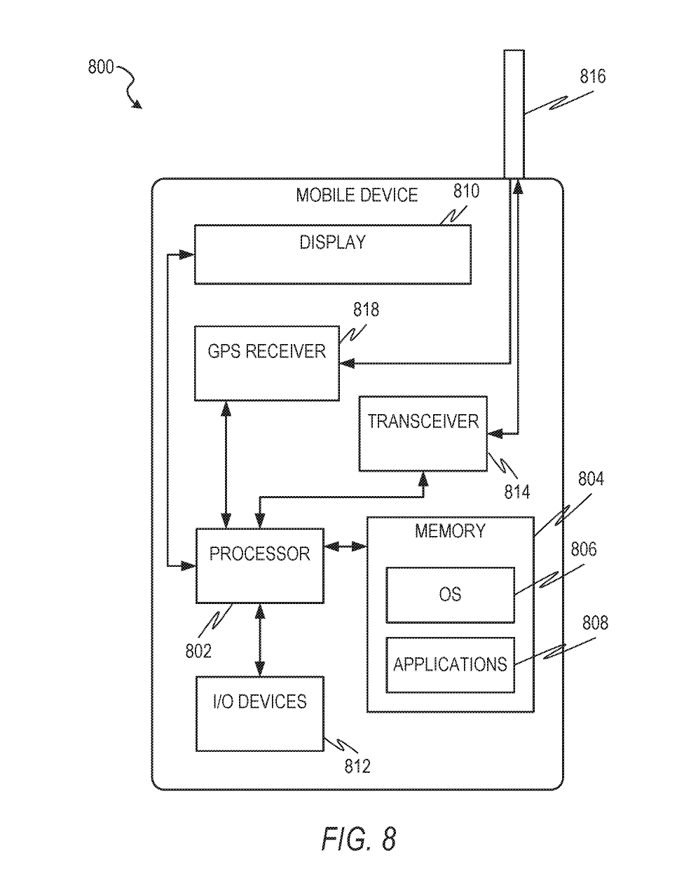

FIG. 8 is a block diagram illustrating a mobile device 800, in accordance with some example embodiments. The mobile device 800 can include a processor 802. The processor 802 can be any of a variety of different types of commercially available processors suitable for mobile devices 800 (for example, an XScale architecture microprocessor, a Microprocessor without Interlocked Pipeline Stages (MIPS) architecture processor, or another type of processor). A memory 804, such as a random access memory (RAM), a Flash memory, or other type of memory, is typically accessible to the processor 802. The memory 804 can be adapted to store an operating system (OS) 806, as well as application programs 808, such as a mobile location enabled application that can provide location-based services (LBSs) to a user. The processor 802 can be coupled, either directly or via appropriate intermediary hardware, to a display 810 and to one or more input/output (I/O) devices 812, such as a keypad, a touch panel sensor, a microphone, and the like. Similarly, in some example embodiments, the processor 802 can be coupled to a transceiver 814 that interfaces with an antenna 816. The transceiver 814 can be configured to both transmit and receive cellular network signals, wireless data signals, or other types of signals via the antenna 816, depending on the nature of the mobile device 800. Further, in some configurations, a GPS receiver 818 can also make use of the antenna 816 to receive GPS signals.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 114 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

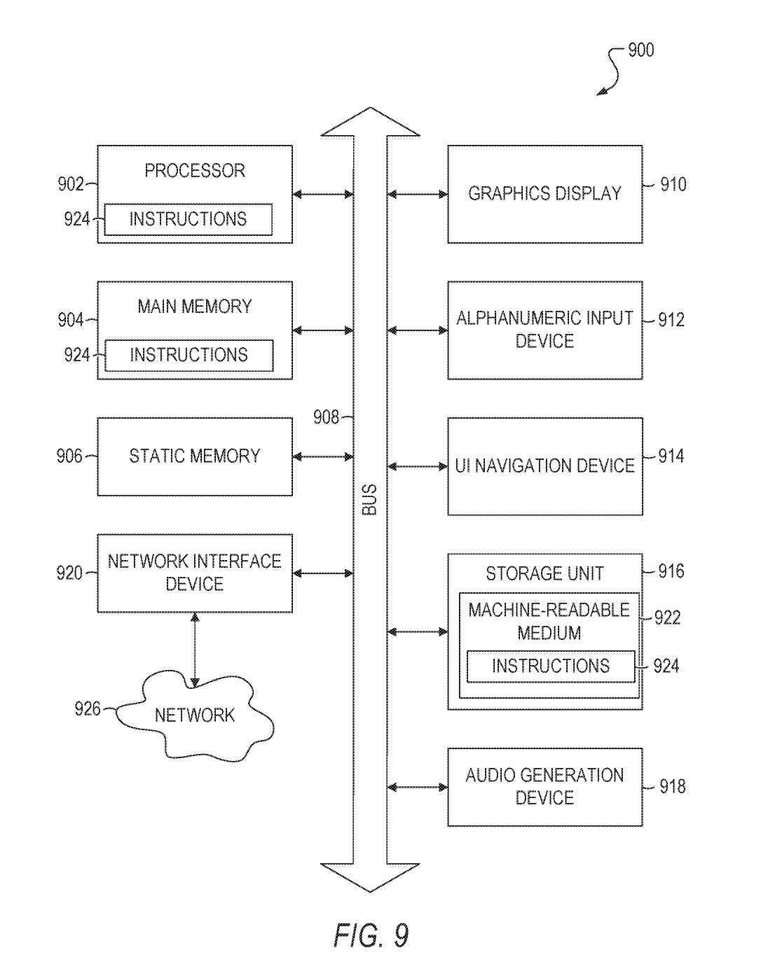

FIG. 9 is a block diagram of a machine in the example form of a computer system 900 within which instructions 924 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a graphics or video display unit 910 (e.g., a liquid crystal display (LCD) or a cathode ray tube (CRT)). The computer system 900 also includes an alphanumeric input device 912 (e.g., a keyboard), a user interface (UI) navigation (or cursor control) device 914 (e.g., a mouse), a storage unit (e.g., a disk drive unit) 916, an audio or signal generation device 918 (e.g., a speaker), and a network interface device 920.

The storage unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media. The instructions 924 may also reside, completely or at least partially, within the static memory 906.

While the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Each of the features and teachings disclosed herein can be utilized separately or in conjunction with other features and teachings to provide a system and method of the present disclosure. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The example methods or algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
at least one processor; and
a non-transitory computer-readable medium storing executable instructions that, when executed, cause the at least one processor to perform operations comprising:
receiving a plurality of transaction data items, each one of the plurality of transaction data items corresponding to a distinct event;
persisting the plurality of transaction data items in a first database in response to the receiving the plurality of transaction data items;
persisting a copy of the plurality of transaction data items as a plurality of auxiliary data items in a second database different from the first database in response to the receiving the plurality of transaction data items;
detecting a manipulation of the plurality of transaction data items;
updating the plurality of auxiliary data items in the second database based on the detecting of the manipulation of the plurality of transaction data items;
performing at least one online analytical processing operation using the plurality of auxiliary data items in the second database; and
accessing the plurality of transaction data items in the first database and generating one or more documents using the accessed plurality of transaction data items subsequent to and independently from the performing of the at least one online analytical processing operation, the generating of the one or more documents being one of a plurality of periodic document generation operations using data from the first database.

2. The system of claim 1, wherein the corresponding distinct events for the plurality of transaction data items comprise telecommunication events.

3. The system of claim 2, wherein the telecommunication events comprise at least one of a voice call event, a text messaging event, and a data transmission event, the data transmission event using an Internet Protocol network.

4. The system of claim 1, wherein the operations further comprise updating the plurality of auxiliary data items in the second database based on the generating of the one or more documents.

5. The system of claim 1, wherein the plurality of transaction data items comprises a plurality of billable items.

6. The system of claim 5, wherein the generating of the one or more documents comprises generating one or more invoice documents.

7. The system of claim 6, wherein the operations further comprise recognizing revenue from the plurality of billable items using the plurality of auxiliary data items in the second database prior to and independently of the generating of the one or more invoice documents.

8. The system of claim 7, wherein the operations further comprising posting the recognized revenue from the plurality of billable items to one or more accounts prior to and independently of the generating of the one or more invoice documents.

9. A computer-implemented method comprising:
receiving a plurality of transaction data items, each one of the plurality of transaction data items corresponding to a distinct event;
persisting the plurality of transaction data items in a first database in response to the receiving the plurality of transaction data items;
persisting a copy of the plurality of transaction data items as a plurality of auxiliary data items in a second database different from the first database;
detecting a manipulation of the plurality of transaction data items;
updating the plurality of auxiliary data items in the second database based on the detecting of the manipulation of the plurality of transaction data items;
performing, by a machine having a memory and at least one hardware processor, at least one online analytical processing operation using the plurality of auxiliary data items in the second database; and
accessing the plurality of transaction data items in the first database and generating one or more documents using the accessed plurality of transaction data items subsequent to and independently from the performing of the at least one online analytical processing operation, the generating of the one or more documents being one of a plurality of periodic document generation operations using data from the first database.

10. The computer-implemented method of claim 9, wherein the corresponding distinct events for the plurality of transaction data items comprise telecommunication events.

11. The computer-implemented method of claim 10, wherein the telecommunication events comprise at least one of a voice call event, a text messaging event, and a data transmission event, the data transmission event using an Internet Protocol network.

12. The computer-implemented method of claim 9, further comprising updating the plurality of auxiliary data items in the second database based on the generating of the one or more documents.

13. The computer-implemented method of claim 9, wherein the plurality of transaction data items comprises a plurality of billable items.

14. The computer-implemented method of claim 13, wherein the generating of the one or more documents comprises generating one or more invoice documents.

15. The computer-implemented method of claim 14, further comprising recognizing revenue from the plurality of billable items using the plurality of auxiliary data items in the second database prior to and independently of the generating of the one or more invoice documents.

16. The computer-implemented method of claim 15, further comprising posting the recognized revenue from the plurality of billable items to one or more accounts prior to and independently of the generating of the one or more invoice documents.

17. A non-transitory machine-readable storage medium, tangibly embodying a set of instructions that, when executed by at least one processor, causes the at least one processor to perform operations comprising:
receiving a plurality of transaction data items, each one of the plurality of transaction data items corresponding to a distinct event,
persisting the plurality of transaction data items in a first database in response to the receiving the plurality of transaction data items;
persisting a copy of the plurality of transaction data items as a plurality of auxiliary data items in a second database different from the first database;
detecting a manipulation of the plurality of transaction data items;
updating the plurality of auxiliary data items in the second database based on the detecting of the manipulation of the plurality of transaction data items;
performing at least one online analytical processing operation using the plurality of auxiliary data items in the second database; and
accessing the plurality of transaction data items in the first database and generating one or more documents using the accessed plurality of transaction data items subsequent to and independently from the performing of the at least one online analytical processing operation, the generating of the one or more documents being one of a plurality of periodic document generation operations using data from the first database.

18. The non-transitory machine-readable storage medium of claim 17, wherein the corresponding distinct events for the plurality of transaction data items comprise telecommunication events.

19. The non-transitory machine-readable storage medium of claim 18, wherein the telecommunication events comprise at least one of a voice call event, a text messaging event, and a data transmission event, the data transmission event using an Internet Protocol network.

20. The non-transitory machine-readable storage medium of claim 17, wherein the operations further comprise updating the plurality of auxiliary data items in the second database based on the generating of the one or more documents.
